(19) United States
(12) Patent Application Publication
(10) Pub. No.: US 2026/0140477 A1
(43) Pub. Date: May 21, 2026

(54) HOROLOGY MOVEMENT COMPRISING A POWER RESERVE DISPLAY DEVICE COMPRISING A PLANETARY MECHANISM

(71) Applicant: Montres Breguet S.A., L'Abbaye (CH)

(72) Inventor: Pascal FRIDERICI, L'Orient (CH)

(73) Assignee: Montres Breguet S.A., L'Abbaye (CH)

(21) Appl. No.: 19/311,732

(22) Filed: Aug. 27, 2025

(30) Foreign Application Priority Data
Nov. 19, 2024 (EP) 24213825.3

(51) Int. Cl. G04B 9/00; G04B 13/00

(52) U.S. Cl. CPC G04B 9/005; G04B 13/008

(57) ABSTRACT

A horology movement including at least one barrel (11, 12) and a device for displaying a power reserve (10), including a winding mechanism having a winding train (22), a reduction train (15) meshing with the or one of the barrels (11; 12), a differential gear (13) arranged so as to kinematically join the winding train (22) and the barrel (11) via a first entry on the differential gear (13), the differential gear (13) including a second entry by which it is joined to the reduction train (15), and including an exit, a power reserve display module (16) including a planetary mechanism (160) engaging with the exit on the differential gear (13).

### CROSS REFERENCE TO RELATED APPLICATIONS

This application claims priority to European Patent Application No. 24213825.3 filed Nov. 19, 2024, the entire contents of which are incorporated herein by reference.

### TECHNICAL FIELD OF THE INVENTION

The invention relates to the field of horology and, in particular, to a horology movement comprising a device for displaying a power reserve comprising a planetary mechanism.

### TECHNOLOGICAL BACKGROUND

In a horology movement, a power reserve display device is a horological complication that enables a user to know the level of energy available for displaying the hour or any other time indication. In other words, a power reserve display device makes it possible to indicate the charge level of the barrel(s) in the horology movement.

A power reserve display device comprises a power reserve indicator, such as a hand, and a differential gear joining the indicator to the barrel(s), as described in document EP3333637.

Power reserve display devices generally comprise numerous components so as to display adequate reduction ratios between the barrel(s) in the horology movement and the power reserve indicator. These numerous components significantly impact the cost of the horology movements in which they are incorporated and require a significant volume for their incorporation into said horology movements.

### SUMMARY OF THE INVENTION

The invention remedies the aforementioned drawbacks by providing a horology movement comprising at least one barrel and a device for displaying the power reserve.

The power reserve display device comprises a winding mechanism comprising a winding train, a reduction train meshing with the barrel or one of the barrels, and a differential gear arranged so as to kinematically join the winding train and the barrel via a first entry on the differential gear. The differential gear comprises a second entry by which it is joined to the reduction train, and an exit. The first and second entries and the exit on the differential gear are preferentially arranged coaxially relative to each other.

The power reserve display device further comprises a power reserve display module comprising a planetary mechanism engaging with the exit on the differential gear.

These characteristics advantageously reduce the number of components in the power reserve display device and thereby its overall volume.

Moreover, due to the planetary mechanism, the reduction ratio between the barrel(s) and an indicator on the power reserve display module can be relatively high, within a relatively small volume.

In particular embodiments, the invention can further comprise one or more of the following features, taken separately or in any technically possible combination.

In particular embodiments, the planetary mechanism comprises a planetary entry wheel driven on a planetary axis with a planetary pinion engaging with a satellite. The planetary mechanism further comprises a crown immobilised on a structure in the horology movement and comprising internal toothing by which the crown meshes with the satellite.

The satellite is carried by a satellite carrier capable of rotating a planetary exit pinion around the planetary axis.

In particular embodiments, the satellite carrier is friction-fitted on the planetary exit pinion.

In particular embodiments, the power reserve display module comprises a power reserve indicator axis arranged so as to be rotationally mobile in the crown and rotationally secured to the planetary exit pinion such that the rotation of the latter rotates the power reserve indicator axis.

In particular embodiments, the differential gear comprises a differential gear satellite carried by a differential gear satellite carrier secured so as to rotate freely on a differential gear axis, the differential gear satellite carrier constituting the first entry on the differential gear and meshing with the barrel.

In particular embodiments, the second entry on the differential gear is constituted by a solar mobile mounted so as to be rotationally mobile on the differential gear axis, the solar mobile comprising a solar wheel meshing with the reduction train and a solar pinion meshing with the differential gear satellite.

In particular embodiments, the exit on the differential gear consists of a first and a second exit wheel rotationally secured to the differential gear axis.

In particular embodiments, the planetary mechanism engages with the exit on the differential gear via a reduction mobile, the reduction mobile comprising a reduction wheel meshing with the second exit wheel on the differential gear, and a reduction pinion meshing with the planetary entry wheel.

In particular embodiments, the horology movement comprises a first and a second barrel each comprising a ratchet wheel, both meshing with an intermediate wheel, the first barrel comprising a drum joining it to the differential gear and the second barrel comprising a drum joining it to the reduction train.

### BRIEF DESCRIPTION OF THE FIGURES

Other features and advantages of the invention will become apparent from the following detailed description, given by way of non-limiting example, with reference to the attached drawings in which:

FIG. 1 shows a perspective view from below of two barrels and of a device for displaying the power reserve in a horology movement according to a preferred exemplary embodiment of the invention,

FIG. 2 shows a perspective top view of two barrels and of a device for displaying the power reserve in a horology movement according to a preferred exemplary embodiment of the invention,

FIG. 3 shows a close-up view of FIG. 2, in which a differential gear on the display device and a planetary mechanism can be seen,

FIG. 4 shows a cross-sectional view of the differential gear on the power reserve display device in FIG. 3,

FIG. 5 shows a cross-sectional view of the planetary mechanism on the power reserve display device in FIG. 3.

It should be noted that the figures are not necessarily drawn to scale for clarity reasons.

### DETAILED DESCRIPTION OF THE INVENTION

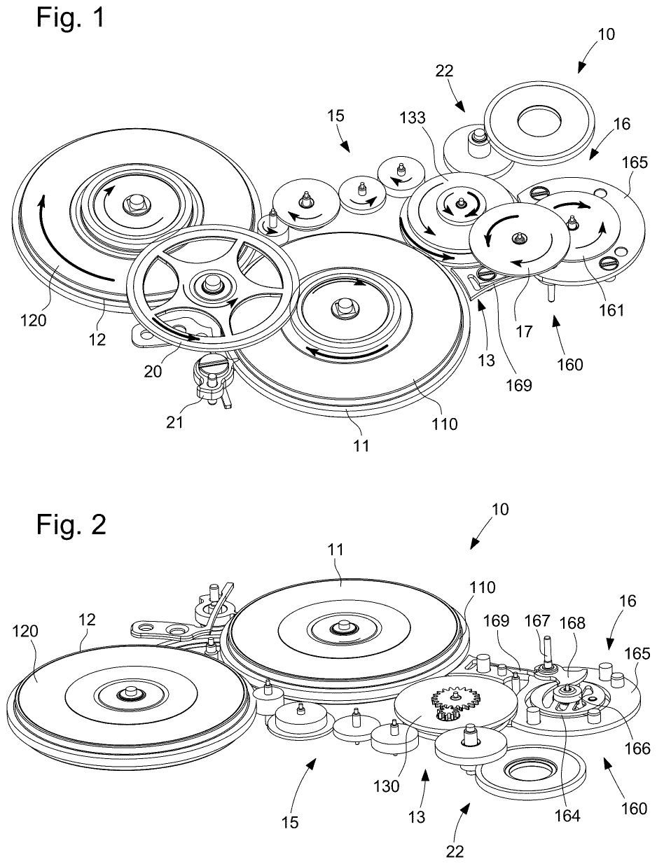

FIGS. 1 and 2 show two barrels and a device for displaying the power reserve 10 in a horology movement according to a preferred exemplary embodiment of the invention.

As can be seen in FIG. 1, the horology movement according to the invention comprises a first barrel 11 and a second barrel 12 kinematically joined to each other by an intermediate wheel 20 and each comprising a barrel spring, in a manner known per se to persons skilled in the art.

More specifically, the first and second barrels 11 and 12 each comprise a drum 110 and 120 and a ratchet wheel 111 and 121 both preferentially meshing with the intermediate wheel 20.

The drum 110 on the first barrel 11 engages with a click 21 such that said drum 110 is locked in one direction of rotation by said click 21, in a manner known per se to persons skilled in the art. The spring in the second barrel 12 is let down when the horology movement is running in a manner known per se and rotates a finishing train (not shown in the figures) via the drum 120.

The power reserve display device 10 comprises a differential gear 13 kinematically inserted between a winding train 22 on a winding mechanism and the first barrel 11. In other words, the differential gear 13 is arranged so as to kinematically join the winding train 22 and the first barrel 11.

The winding mechanism can be acted upon via a winding crown joined to a winding stem, and/or via an oscillating mass. The winding mechanism is known per se to the person skilled in the art and is therefore not described in further detail below.

The differential gear 13 engages with the drum 110 on the first barrel 11 via a first entry which, in the exemplary embodiment of the invention shown in the figures, consists of a differential gear satellite carrier 130 carrying a differential gear satellite 131. More specifically, the differential gear 13 comprises a differential gear axis 132 on which the differential gear satellite carrier 130 is mounted so as to rotate freely, as shown in particular in FIG. 4.

The differential gear 13 also comprises a second entry joined to the second barrel 12 by a reduction train 15. The second entry consists of a solar mobile 133 mounted so as to rotate freely on the differential gear axis 132, said solar mobile 133 comprising a solar wheel 1331 meshing with the reduction train 15 and a solar pinion meshing with the differential gear satellite 131.

The springs in the first and second barrels 11 and 12 are wound when the drum 110 on the first barrel 11 is driven by the differential gear satellite carrier 130 in a given direction of rotation, after the winding train 22 has been acted upon in the winding direction.

As shown in FIG. 4, the differential gear 13 comprises an exit consisting of a first exit wheel 134 and a second exit wheel 135 driven on the differential gear axis 132. The first exit wheel 134 meshes with the differential gear satellite 131, such that the differential gear satellite 131 can roll around the first exit wheel 134 or rotate it.

Advantageously, the first and second entries and the first and second exit wheels 134 and 135 on the differential gear 13 are thus coaxially arranged with each other. This characteristic reduces the volume occupied by the differential gear 13 within the horology movement. This particularly compact arrangement makes it possible to reduce the volume required within the horology movement to incorporate the differential gear 13.

The power reserve display device 10 comprises a power reserve display module 16 engaging with the exit on the differential gear 13, and more specifically with the second exit wheel 135. In particular, the second exit wheel 135 is joined to a planetary mechanism 160 in the power reserve display module 16, preferentially by a reduction mobile 17, as shown in detail in FIG. 4.

In the exemplary embodiment shown in the figures and specifically seen in FIG. 5, the planetary mechanism 160 comprises a planetary entry wheel 161 meshing with the reduction mobile 17. The planetary entry wheel 161 is driven on a planetary axis 162 comprising a planetary pinion engaging with a satellite 163 carried by a satellite carrier 164.

In particular, the reduction mobile 17 comprises a reduction wheel meshing with the second exit wheel 135 on the differential gear 13, and a reduction pinion meshing with the planetary entry wheel 161.

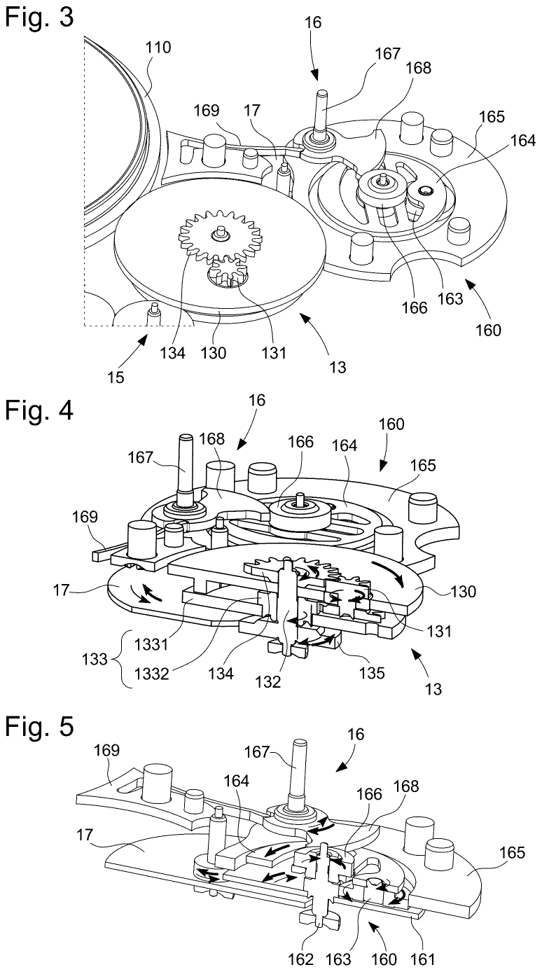

The planetary mechanism 160 further comprises a crown 165 with internal toothing with which the satellite 163 meshes. As can be seen in FIGS. 2 and 3, the crown 165 is secured without any degree of freedom to a structure in the horology movement, for example a bar or a plate.

The planetary mechanism 160 further comprises a planetary exit pinion 166 that can be rotated around the planetary axis 162. More specifically, the planetary exit pinion 166 is mounted so as to rotate freely on the planetary axis 162.

As can be seen in FIGS. 2, 3 and 5, the satellite carrier 164 is preferentially friction-fitted on the planetary exit pinion 166. The satellite carrier 164 can therefore transmit a couple to the planetary exit pinion 166 so as to rotate it up to a maximum couple at which the satellite carrier 164 slides on said planetary exit pinion 166.

In the exemplary embodiment of the invention shown in the figures, and in particular in FIGS. 3 to 5, the satellite carrier 164 consists of a rim carrying the satellite 163 and of two resilient arms with their ends joined to the rim. The resilient arms are arranged so as to define a hole in which an annular portion of the planetary exit pinion 166 is engaged.

Advantageously, the power reserve display module 16 comprises a power reserve indicator axis 167 arranged so as to be rotationally mobile in the crown 165, that is, in the body of the part forming the crown 165, as can be seen in FIGS. 3 and 5 in particular. This power reserve indicator axis 167 is rotationally secured to the planetary exit pinion 166, such that the rotation of the latter rotates the power reserve indicator axis 167. More specifically, a rack 168 is driven onto the power reserve indicator axis 167 and meshes with the planetary exit pinion 166. An indicator (not shown in the figures), such as a hand or a disc, is secured to the power reserve indicator axis 167.

Advantageously, the power reserve display module 16 comprises a spring 169 arranged to bear against the power reserve indicator axis 167 so as to exert a return stress thereon. In particular, the rack 168 can have a notch in which one end of the spring 169 is embedded.

Conventionally, the power reserve indicator axis 167 has two extreme angular positions, in one of which it indicates that the barrel springs are fully wound, and in the other that the barrel springs are fully let down. These extreme angular positions are, for example, delimited by end stops (not shown in the figures) secured to the crown 165 or to a structure in the horology movement, such as a plate or a bar, and against which the power reserve indicator axis 167, particularly the rack 168, is designed to bear.

To sum up, when the winding train 22 is acted upon in the winding direction, the drum 110 on the first barrel 11 is rotated by the differential gear satellite carrier 130, as shown by the bolded arrows in the figures. The differential gear satellite carrier 130 drives the differential gear satellite 131 in a circular motion centred around the differential gear axis 132. The differential gear satellite 131 then turns around the first exit wheel 134 by rotating it and rolling around the solar pinion without transmitting any movement thereto.

The second exit wheel 135 is rotated by the first exit wheel 134 and rotates the planetary entry wheel 161 via the reduction mobile 17. As can be specifically seen in FIG. 5, as the planetary entry wheel 161 turns, it rotates the satellite 163 around its axis and around the planetary axis 162, and thereby rotates the satellite carrier 164. The satellite carrier 164 frictionally transmits a couple to the planetary exit pinion 166, thereby causing it to rotate, which causes the rack 168 to rotate and consequently the power reserve indicator axis 167 to move.

The power reserve indicator axis 167 is driven in a direction in which the indicator indicates an increase in the power reserve.

This movement is carried out until the power reserve indicator axis 167 reaches one of its extreme angular positions, the satellite carrier 164 then sliding against the planetary exit pinion 166 due to the rack 168 being rotationally locked by the end stop.

During the movement described above, the second barrel 12 is progressively wound by the first barrel 11. In particular, once the spring in the second barrel 12 is sufficiently wound, it rotates the drum 120 on the second barrel 12 so as to release the finishing train and thereby the start the horology movement. The rotation of the drum 120 on the second barrel 12 rotates the solar wheel 1331 via the reduction train 15.

Furthermore, when the winding train 22 is not acted upon and the springs in the first and second barrels 11 and 12 are letting down, that is, when the horology movement is running, the drum 120 on the second barrel 12 transmits, via the reduction train 15, a rotational movement to the solar wheel 1331, as described above, and to the differential gear satellite 131.

When rotating, the differential gear satellite 131 rotates the first differential gear exit wheel 134 and thereby rotates the second differential gear exit wheel 135. The planetary entry wheel 161 is then rotated by the reduction mobile 17, which in turn drives the satellite carrier 164 via the satellite 163.

In a similar manner to the one described above, the satellite carrier 164 frictionally transmits a couple to the planetary exit pinion 166, thereby rotating it, which causes the rack 168 to rotate and consequently the power reserve indicator axis 167 to move.

The power reserve indicator axis 167 is driven in a direction in which the indicator indicates a decrease in the power reserve.

The arrangement of the differential gear 13 and the planetary mechanism 160 advantageously makes it possible to offer a substantial reduction in movement between the rotation of the drum 110 on the first barrel 11 and that of the power reserve indicator within a limited volume, when the spring in the first barrel 11 is wound. By way of example, the power reserve indicator can be driven by a fraction of a turn, for example between 0.1 and 0.2 turns, when the drum 110 on the first barrel 11 is driven by several dozen turns, for example between 25 and 30 turns.

Similarly, while the springs in the first and second barrels 11 and 12 are letting down, due to the reduction train 15 and due to the arrangement of the differential gear 13 and the planetary mechanism 160, the drum 120 on the second barrel 12 can make several dozen turns, for example between 25 and 30 turns, and drive the power reserve indicator to make a fraction of a turn, for example between 0.1 and 0.2 turns.

In another exemplary embodiment of the invention not shown in the figures, it could be foreseen that the horology movement according to the invention comprises a single barrel comprising a barrel spring in a manner known per se by the person skilled in the art. The barrel also comprises a drum and a ratchet wheel.

In this exemplary embodiment, the ratchet wheel is kinematically joined to the satellite carrier on the differential gear so as to be rotated by the latter when the winding train 22 is acted upon in a winding direction. This characteristic makes it possible to wind the barrel spring. In this exemplary embodiment of the invention, an intermediate wheel 20 is inserted between the ratchet wheel and the differential gear satellite carrier.

Similar to what has been described above, the ratchet wheel engages with a click such that it is rotationally locked when the horology movement is running. Then only the drum is rotated under the effect of the let-down of the barrel spring.

The drum is joined to the second entry on the differential gear 13, namely the solar wheel 1331, via the reduction train 15.

More generally, it should be noted that the embodiments and uses considered above have been described by way of non-limiting examples, and that other variants are therefore conceivable.

In particular, it is conceivable that the power reserve display module 16 comprises at least one intermediate wheel meshing with a mobile carrying a power reserve indicator so as to shift the power reserve display.

1. A horology movement comprising at least one barrel (11, 12) and a device for displaying a power reserve (10), the horology movement being characterised in that said device comprises:
a winding mechanism comprising a winding train (22),
a reduction train (15) meshing with the or one of the barrels (11; 12),
a differential gear (13) arranged so as to kinematically join the winding train (22) and the barrel (11) via a first entry on the differential gear (13), said differential gear (13) comprising a second entry by which it is joined to the reduction train (15), and comprising an exit,
a power reserve display module (16) comprising a planetary mechanism (160) engaging with the exit on the differential gear (13).

2. The horology movement according to claim 1, wherein the planetary mechanism (160) comprises a planetary entry wheel (161) driven on a planetary axis (162) with a planetary pinion engaging with a satellite (163), the planetary mechanism (160) further comprising a crown (165) immobilised on a structure in the horology movement and comprising internal toothing meshing with the satellite (163), the planetary mechanism (160) comprising a satellite carrier (164) carrying the satellite (163) and being capable of rotating a planetary exit pinion (166) around the planetary axis (162).

3. The horology movement according to claim 2, wherein the power reserve display module (16) comprises a power reserve indicator axis (167) arranged so as to be rotationally mobile in the crown (165) and rotationally secured to the planetary exit pinion (166) such that the rotation of the latter rotates the power reserve indicator axis (167).

4. The horology movement according to claim 2, wherein the satellite carrier (164) is friction-mounted on the planetary exit pinion (166).

5. The horology movement according to claim 1, wherein the differential gear (13) comprises a differential gear satellite (131) carried by a differential gear satellite carrier (130) secured so as to rotate freely on a differential gear axis (132), the differential gear carrier (130) forming the first entry on the differential gear (13) and meshing with the barrel (11).

6. The horology movement according to claim 5, wherein the second entry on the differential gear (13) is constituted by a solar mobile (133) mounted so as to be rotationally mobile on the differential gear axis (132), the solar mobile (133) comprising a solar wheel (1331) meshing with the reduction train (15) and a solar pinion meshing with the differential gear satellite (131).

7. The horology movement according to claim 5, wherein the exit on the differential gear (13) is formed by a first and a second exit wheel (134, 135) rotationally secured to the differential gear axis (132).

8. The horology movement according to claim 2, wherein the exit on the differential gear (13) is formed by a first and a second exit wheel (134, 135) rotationally secured to the differential gear axis (132), the planetary mechanism (160) engaging with the exit on the differential gear (13) via a reduction mobile (17), the reduction mobile (17) comprising a reduction wheel meshing with the second exit wheel (135) on the differential gear (13), and a reduction pinion meshing with the planetary entry wheel (161).

9. The horology movement according to claim 1, comprising a first and a second barrel (11, 12) each comprising a ratchet wheel (111,

121, both meshing with an intermediate wheel (20), the first barrel (11) comprising a drum (110) joining it to the differential gear (13) and the second barrel (12) comprising a drum (120) joining it to the reduction train (15).
